(19) United States
(12) Patent Application Publication
(10) Pub. No.: US 2011/0177840 A1
(43) Pub. Date: Jul. 21, 2011

(54) FOLDING HANDHELD DEVICE

(75) Inventor: FRANK HUANG, SHANGHAI (CN)

(73) Assignees: INVENTEC APPLIANCES (SHANGHAI) CO. LTD., SHANGHAI (CN); INVENTEC APPLIANCES CORP., TAIPEI COUNTY (TW)

(21) Appl. No.: 12/907,332

(22) Filed: Oct. 19, 2010

(30) Foreign Application Priority Data
Jan. 15, 2010 (CN) 201010022836.3

(51) Int. Cl. H04M 1/00

(52) U.S. Cl. 455/556.1; 455/575.3

(57) ABSTRACT

The present invention discloses a folding handheld device, comprising a first casing, a second casing, a pivot device, and a screen driving device. Wherein, the first casing includes a first screen and a first driving device for driving the first screen, and the second casing includes a second screen and a second driving device for driving the second screen. The pivot device is pivotally coupled to lateral edges of the first casing and the second casing. The screen driving device integrates the first driving device and the second driving device to drive the first screen and the second screen to form a third screen upon the first casing and the second casing situated on the same plane.

### BACKGROUND OF THE INVENTION

1. Field of the Invention

The present invention relates to a handheld device, and more particularly to a folding handheld device.

2. Description of Related Art

In recent years, multifunctional handheld devices advance day by day, and more and more handheld devices with new functions are introduced to the market. In our daily life, the common handheld devices include mobile phones, palm computers, handheld global positioning systems, etc. Particularly for the mobile phones, they are used for making and receiving calls and sending and receiving short messages, as well as taking pictures, logging on the Internet, working, playing games, and traveling or looking up maps via the global positioning system, etc. Users can access the Internet functions via the mobile phones to play videos or working on the network anytime and anywhere. Among the mobile phones, a GPS mobile phone is a multifunctional electronic product that integrates a GPS navigation function into the mobile phone to achieve the effects of locating a position accurately, inquiring a facility location, and looking for a navigation path. The GPS mobile phone is portable and convenient, and users can use it for navigation anytime and anywhere. As the technology of products of this sort has become matured, the mobile phone comes with a video playing interface having a smooth and clear screen, a powerful GPS function, an excellent signal receiving capability, and an accurate positioning feature.

In general, most handheld devices do not come with a large screen, and the small screen limits the size of the video playing interface and navigation interface, thus resulting in a poor visual effect and a low resolution for the GPS navigation that fails to allow users to identify the navigation path. Now, the professional GPS devices available in the market have large and clear screens, but the volume is too large and not suitable to be integrated into the handheld device.

### SUMMARY OF THE INVENTION

In the light of the above-mentioned shortcomings of existing functional handheld devices, the present invention is to provide a folding handheld device comprising a first casing, a second casing, a pivot device, and a screen driving device. Wherein, the first casing includes a first screen and a first driving device for driving the first screen. The second casing includes a second screen and a second driving device for driving the second screen. The pivot device is pivotally coupled to lateral edges of the first casing and the second casing. The screen driving device integrates the first driving device and the second driving device to drive the first screen and the second screen to form a third screen upon the first casing and the second casing situated on the same plane.

Preferably, size and shape of the first casing are substantially equal to size and shape of the second casing.

Preferably, the third screen has an area equal to the sum of an area of the first screen and an area of the second screen.

The folding handheld device disclosed by the present invention may be a mobile phone, a notebook computer, a palmtop computer, an electronic dictionary, an electronic book, a handheld global positioning system, etc. In embodiments of the present invention, the mobile phone is cited as an example of the folding handheld device for description. The folding handheld device disclosed by the present invention may further include a fourth screen and an operating key disposed on a surface of the first casing. The fourth screen and the operating key may be disposed on the backside of the first screen of the first casing. Wherein, the operating key may include an answer key and a function key. Upon the first casing disposed on the second casing, a caller ID function and an answer function can be provided by the fourth screen and the answer key, respectively. Also, a simple menu display can be shown using the function key and the fourth screen. For example, a phone book, an address book, a notepad, etc. can be displayed on the fourth screen by operating the function key. Upon the first casing and the second casing having an included angle between 0° and 180°, the first screen is a mobile phone screen, and the second screen is a touch full keyboard such that various functions of the existing full keyboards, such as enjoying multimedia entertainment, surfing the Internet and working, can be achieved.

Preferably, the first screen and the second screen are designed with no borders, or at least the interface between the first screen and the second screen is designed with no borders such that a frame, size of which corresponds to size of the third screen, can be completely shown on the third screen composed of the first screen and the second screen, thus further providing a better visual effect.

Preferably, the size of the frame to be shown by the third screen is enlarged by the same proportion according to area sizes of the third screen and the first screen.

Preferably, the folding handheld device is a mobile phone having a global positioning system function.

In accordance with the folding handheld device of the present invention, taking the mobile phone as an example, it can be realized that a mobile phone with a touch panel, a mobile phone with a full keyboard, and a professional in-car GPS device are integrated together to become a folding mobile phone with full functions. The screen driving device integrates the first driving device and the second driving device to drive the first screen and the second screen to form a third screen upon the first casing and the second casing situated on the same plane. The third screen having a large area composed of the first screen and second screen not only is used as a display interface of the professional in-car GPS device, but also lets the user experience the same feeling as operating a notebook computer while using the multimedia entertainments, such as playing MP4, surfing the Internet, working and playing games, thereby eliminating the drawback of small mobile phone screen.

Moreover, the present invention for application in the notebook computer or palmtop computer will provide users with larger visual screen, further obtaining the better visual effect.

### BRIEF DESCRIPTION OF THE DRAWINGS

FIG. 1 illustrates a structure schematic diagram of a first casing disposed on a second casing in a folding mobile phone;

FIG. 2 illustrates a schematic diagram of the first casing and the second casing having a certain included angle between 0° and 180° in the folding mobile phone; and

FIG. 3 illustrates a schematic diagram of the third screen formed by the first screen and the second screen upon the first casing and the second casing situated on the same plane in the folding mobile phone.

### DETAILED DESCRIPTION OF THE PREFERRED EMBODIMENTS

The embodiments of the present invention will be described in detail with reference to the accompanying drawings. To facilitate the understanding of the description, the same reference indicators will be used throughout the drawings and the following detailed description to refer to the same parts.

The folding handheld device of the present invention may be a mobile phone, a notebook computer, a palmtop computer, an electronic dictionary, an electronic book, a handheld global positioning system, etc. In the following embodiments, the mobile phone is used as an example of the folding handheld device.

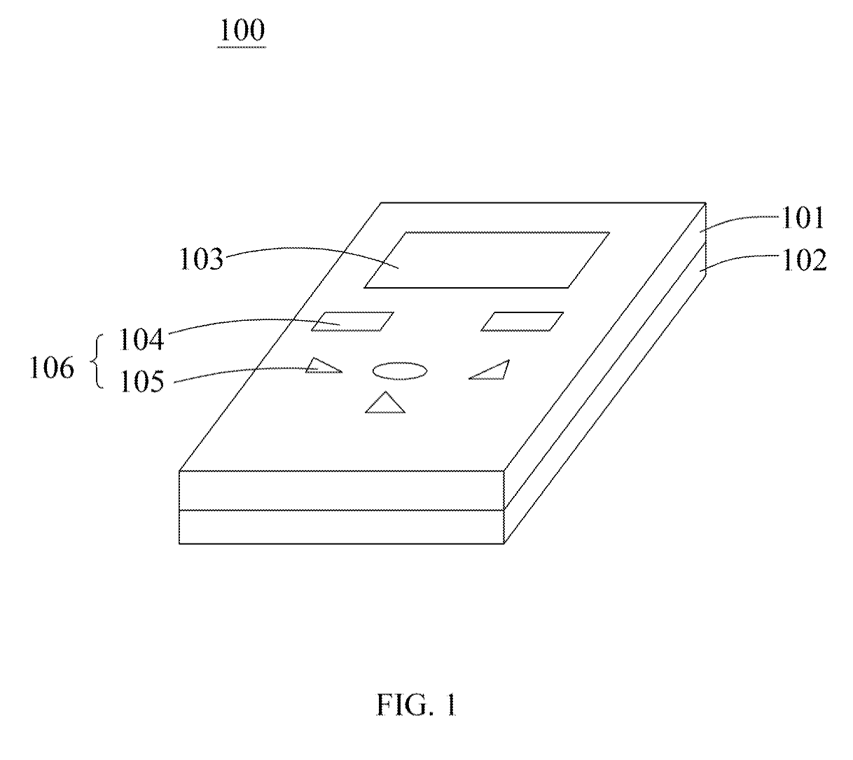

FIG. 1 illustrates a structure schematic diagram of a first casing disposed on a second casing in accordance with a folding mobile phone. Please refer to FIG. 1. The first casing 101 is disposed on the second casing 102 in the folding mobile phone 100, and the size and shape of the first casing 101 are substantially equal to the size and shape of the second casing 102. A fourth screen 103 and an operating key 106 are disposed on a surface of the first casing 101. The operating key 106 includes an answer key 104 and a function key 105. When the folding mobile phone 100 receives a call, the call can be answered or rejected by using the fourth screen 103 or the answer key 104 upon the folding mobile phone 100 being folded. Furthermore, a menu display can be shown by using the function key 105 and the fourth screen 103. For example, a phone book, an address book, a notepad, etc. can be displayed on the fourth screen 103 by operating the function key 105.

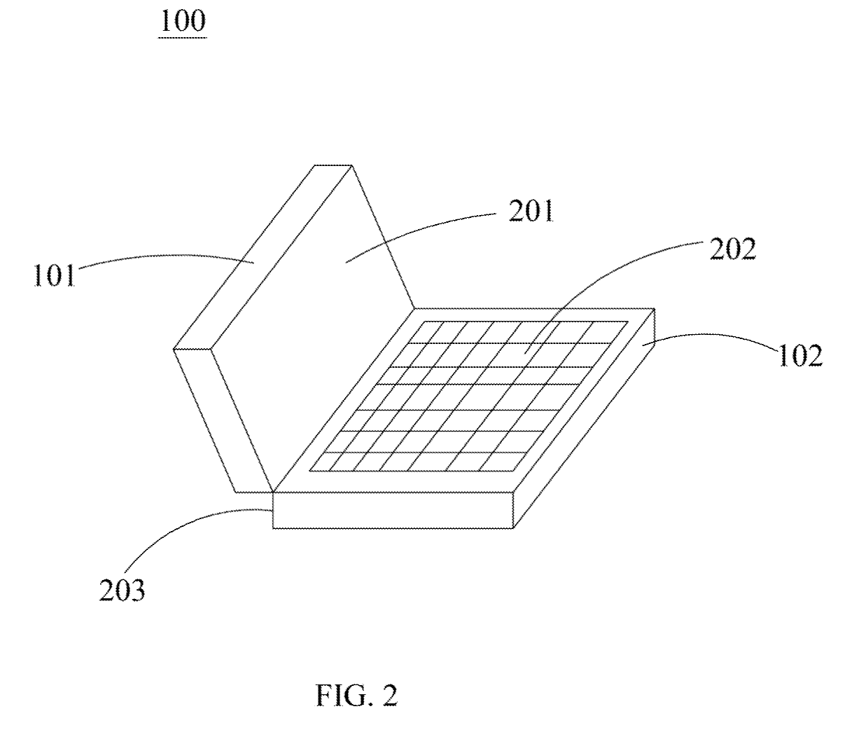

FIG. 2 illustrates a schematic diagram of the first casing and the second casing having a certain included angle between 0° and 180° in the folding mobile phone. Please refer to FIG. 2. The folding mobile phone 100 comprises the first casing 101, the second casing 102, a pivot device 203, and a screen driving device (not shown). Wherein, the first casing 101 includes a first screen 201 and a first driving device (not shown) for driving the first screen 201, and the second casing 102 includes a second screen 202 and a second driving device (not shown) for driving the second screen 202. The pivot device 203 is pivotally coupled to lateral edges of the first casing 101 and the second casing 102. While an included angle between the first casing 101 and the second casing 102 is between 0° and 180°, the folding mobile phone 100 is in a non-folded state. The first casing 101 and the second casing 102 are combined into a folding structure. Wherein, the first screen 201 of the first casing 101 is a screen of the folding mobile phone 100, and the fourth screen 103 and the operating key 106 are disposed on the backside of the first screen 201 of the first casing 101. The second screen 202 of the second casing 102 is a touch full keyboard capable of achieving various functions of the existing full keyboards, such as enjoying multimedia entertainment, surfing the Internet and working. When the first screen 201 of the first casing 101 is disposed on the second screen 202 of the second casing 102, the folding mobile phone 100 is in a folded state, as shown in FIG. 1.

Those skilled in the art should understand that the included angle between the first casing 101 and the second casing 102 are not limited in said angle in the present embodiments. That is, the included angle between the first casing 101 and the second casing 102 can range between 0° and 180°, and various functions of the full keyboards can be achieved.

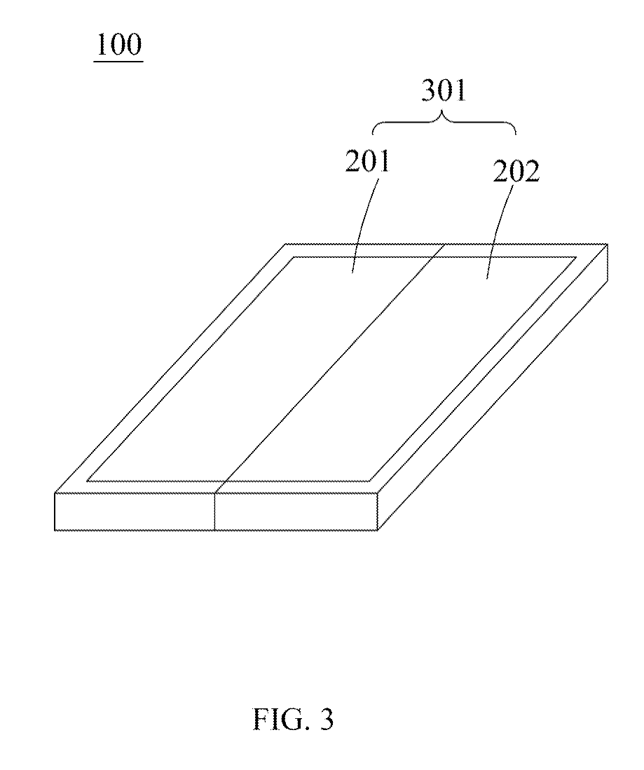

FIG. 3 illustrates a schematic diagram of the third screen formed by the first screen and the second screen upon the first casing and the second casing situated on the same plane in accordance with the folding handheld device. Please refer to FIG. 3. The screen driving device integrates the first driving device and the second driving device to drive the first screen 201 and the second screen 202 to form a third screen 301 upon the first casing 101 and the second casing 102 situated on a same plane, that is, the included angle between the first casing 101 and the second casing 102 is equal to 180°. The third screen 301 has an area equal to the sum of an area of the first screen 201 and an area of the second screen 202. The first screen 201 and the second screen 202 can be designed with no borders, or at least the interface between the first screen 201 and the second screen 202 is designed with no borders such that a frame, size of which corresponds to size of the third screen 301, can be completely shown on the third screen 301 formed by combining the first screen 201 with the second screen 202, thus further providing a better visual effect. Preferably, the size of the frame to be shown by the third screen 301 is enlarged by the same proportion according to area sizes of the third screen 301 and the first screen 201.

The third screen 301 having a large area formed by combining the first screen 201 with the second screen 202 not only is used as a display interface of the professional in-car GPS device, but also lets the user experience the same feeling as operating a notebook computer while using the multimedia entertainments, such as playing MP4, surfing the Internet, working and playing games, thereby eliminating the current drawback that the mobile phone screen is small.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiments of the present invention.

What is claimed is:

1. A folding handheld device, comprising:
a first casing, including:
a first screen; and
a first driving device, for driving the first screen;
a second casing, including:
a second screen; and
a second driving device, for driving the second screen;
a pivot device, pivotally coupling lateral edges of the first casing and the second casing; and
a screen driving device, for integrating the first driving device and the second driving device to drive the first screen and the second screen to form a third screen upon the first casing and the second casing situated on a same plane.

2. The folding handheld device of claim 1, wherein size and shape of the first casing are substantially equal to size and shape of the second casing.

3. The folding handheld device of claim 1, wherein the third screen has an area equal to the sum of an area of the first screen and an area of the second screen.

4. The folding handheld device of claim 1, wherein the folding handheld device is a mobile phone.

5. The folding handheld device of claim 4, wherein the first casing further includes a fourth screen and an operating key disposed on a surface of the first casing.

6. The folding handheld device of claim 5, wherein the fourth screen and the operating key are disposed on the backside of the first screen of the first casing.

7. The folding handheld device of claim 5, wherein the operating key includes an answer key.

8. The folding handheld device of claim 5, wherein the operating key includes a function key.

9. The folding handheld device of claim 4, wherein the first casing and the second casing have an included angle between 0° and 180°, and the first screen is a mobile phone screen, and the second screen is a touch full keyboard.

10. The folding handheld device of claim 1, wherein the third screen shows a frame, and size of the frame corresponds to size of the third screen.

11. The folding handheld device of claim 1, wherein the folding handheld device is a palmtop computer.

12. The folding handheld device of claim 1, wherein the folding handheld device is a mobile phone having a global positioning system function.
